(19) United States
(12) Patent Application Publication
(10) Pub. No.: US 2002/0060823 A1
(43) Pub. Date: May 23, 2002

(54) Optical subscriber system and transmission line distance monitoring method

(75) Inventor: Katsumi Tomioka, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 10/038,545

(22) Filed: Oct. 24, 2001

(30) Foreign Application Priority Data
Oct. 24, 2000 (JP) 2000-323556

(51) Int. Cl. H04J 14/02; H04B 10/00

(52) U.S. Cl. 359/125; 359/167

(57) ABSTRACT

A transmission line distance monitor/processor unit is provided in station equipment included in an optical subscriber system comprising the station equipment, a plurality of subscriber units, a transmission line for transmitting trailing signals from the station equipment to the plurality of subscriber units and transmitting leading signals from the plurality of subscriber units to the station equipment, and a star coupler for branching trailing signals and combining the leading signals. The transmission line distance monitor/processor unit sends a distance measuring control signal to each of the subscriber units, measures, based on a distance measuring signal returned from each of the subscriber units, the transmission line distance between the station equipment and each of the subscriber units, and judges whether the transmission line distance is larger or smaller than a reference value. By virtue of the above construction, when the transmission line distance exceeds the reference value, the subscriber unit can be stopped to avoid an adverse effect, on the subscriber unit under operation, such that the subscriber unit under operation is brought to an inoperative state.

### FIELD OF THE INVENTION

The invention relates to an optical subscriber system and a transmission line distance monitoring method, and more particularly to an optical subscriber system which, when the transmission line distance between station equipment and a subscriber unit exceeds a reference value, issues an alarm and can stop the start control for the subscriber unit, and a transmission line distance monitoring method.

### BACKGROUND OF THE INVENTION

In advancing access infrastructure for multimedia services, such as FTTH (fiber to the home), the development of an optimal access network (PON: passive optical network) system as means for reducing cost per subscriber line to realize the utilization of optical subscriber lines has been eagerly carried out in the art.

The PON technique is one of techniques for realizing an optical communication network utilizing broadband properties of fibers, and this optical communication network has drawn attention as a network which is suitable for providing multimedia services, such as CATV and VQD, through laying of optical fibers in homes.

In an ATM-PON system, wherein an asynchronous transfer mode (ATM) has been applied to optical lines, optical outputs from station equipment are branched in a star coupler and are input input a plurality of subscriber units. On the other hand, optical outputs from the optical subscriber units are combined in the star coupler and are input into the station equipment.

Regarding this network, studies have been made on the utilization of wavelength multiplexing techniques with a view to realizing high-capacity transmission. In particular, a transfer technique, wherein the wavelength used in trailing data (station equipment→subscriber unit) is different from the wavelength used in leading data (subscriber unit→station equipment), has been proposed and has drawn attention. In this technique, in the case of leading data, a common identical wavelength is used for a plurality of subscribers. Therefore, leading data sent from the subscribers collide against each other within the optical transmission line, and this poses a problem the data cannot be demodulated in the station equipment. In order to avoid this, a method has been proposed wherein the station equipment instructs the plurality of subscribers on the timing of leading data transmission.

In the ATM-PON system typified by ITU-TG.983.1, distance measurement is necessary. When a distance measuring signal has reached the station equipment beyond the distance measuring region, this signal overlaps with the signal of the subscriber unit under operation. This leads to an issue of a transmission line alarm to the subscriber unit under operation, and, thus, there is a fear or the subscriber unit under operation being brought to an inoperative state.

For this reason, in ITU.TG.983.1, the adverse effect on the subscriber unit under operation should be suppressed, and, when a distance measuring signal has reached the station equipment beyond the distance measuring region, the subscriber unit should be supped.

Japanese Patent No. 3047970 discloses a PON system for realizing delay time measurement processing, Japanese Patent Laid-open No. 261617/1999 discloses a method for measuring the delay of an optical subscriber network using a star coupler, and Japanese Patent Laid-Open No. 216803/2000 discloses a method for computing an installation distance through the measurement of the delay time of a PDS optical subscriber system. According to those system and methods, the delay time from the subscriber unit can be measured. Even in these system and methods, however, when the distance measuring signal has reached the station equipment beyond the distance measuring region, the subscriber unit cannot be stopped. Therefore, there is a fear that a transmission line alarm is issued to the subscriber unit under operation and the subscriber unit under operation is brought to an inoperative state.

### SUMMARY OF THE INVENTION

Accordingly, it is an object of the invention to provide an optical subscriber system, which comprises a station equipment, a plurality of subscriber units, a transmission line for transmitting trailing signals from the station equipment to the plurality or subscriber units and transmitting leading signals from the plurality of subscriber units to the station equipment, and a star coupler for branching trailing signals and combining the leading signals and, when the transfer line distance exceeds a reference value, can stop the subscriber unit, and to provide a transmission line distance monitoring method.

According to the first feature of the invention, an optical subscriber system comprises: station equipment plurality of subscriber units; a transmission line for transmitting trailing signal from the station equipment to the plurality of subscriber units and transmitting leading signals from the plurality of subscriber units to the station equipment; and a star coupler for branching trailing signals and combining the leading signals,

the station equipment comprising a transmission line distance monitor/processor unit which sends a distance measuring control signal to each of the subscriber units, measures, based on a distance measuring signal returned from each of the subscriber units, the transmission line distance between the station equipment and each of the subscriber units, and judges whether the transmission line distance is larger or smaller than a reference value.

By virtue of this construction, the optical subscriber system can judge, whether the transmission line distance is larger or smaller than a reference value, can avoid the collision of leading data, sent from the subscribers, against each other within the optical transmission line, and, thus, can prevent the subscriber unit under operation from being brought to an inoperative state.

In the optical subscriber system according to the first feature of the invention, the station equipment may further comprise a trailing signal multiplexer and a leading signal separator and functions to multiplex the distance measuring control signal, generated in the transmission line distance monitor/processor unit, in the trailing signal multiplexer to prepare a trailing signal, which is then sent to each of the subscriber units, and to separate, from a leading signal returned from each of the subscriber units, a distance measuring signal, in the leading signal separator, which is than sent to the transmission line distance monitor/processor unit.

According to this construction, the optical subscriber system can measure the transmission line distance between the station equipment and the subscriber units, can judge, whether the transmission line distance is larger or smaller than a reference value, can avoid the collision of leading data, sent from the subscribers, against each other within the optical transmission line, and, thus, can prevent the subscriber unit under operation from being brought to an inoperative state.

In this optical subscriber system, preferably,

the transmission line distance monitor/processor unit comprises a distance measuring control signal generator, a distance measuring section, and a distance judgment section, and

the distance measuring control signal generated in the distance measuring control signal generator is multiplexed in the trailing signal multiplexer to prepare a trailing signal, which is then sent to each of the subscriber units, and a distance measuring signal is separated from a leading signal, returned from each of the subscriber units, in the leading signal separator to prepare a distance measuring signal that is then input into the distance measuring section which sends a distance signal to the distance judgment section for judging whether the transmission line distance is larger or smaller than a reference value.

According to this construction, the optical subscriber system can measure the transmission line distance between the station equipment and the subscriber units, can judge, whether the transmission line distance is larger or smaller than a reference value, can avoid the collision of leading data, tent from the subscribers, against each other within the optical transmission line, and, thus, can prevent the subscriber unit under operation from being brought to an inoperative state.

In the above optical subscriber systems, preferably, when the transmission line distance is larger than the reference value, an alarm is issued.

According to this construction, the optical subscriber system can stop a subscriber unit, when the transmission line distance between the station equipment and the subscriber unit is larger than a reference value, can avoid the collision of lading data, sent from the subscribers, against each other within the optical transmission line, and, thus, can prevent the subscriber unit under operation from being brought to an inoperative state.

According to the second feature of the invention, there is provided a method for monitoring the transmission line distance between station equipment and each of a plurality of subscriber units in an optical subscriber system comprising: station equipment, a plurality of subscriber unites; a transmission line for transmitting trailing signals from the station equipment to the plurality of subscriber units and transmitting leading signals from the plurality of subscriber units to the station equipment; and a star coupler for branching trailing signal and combining the leading signals, said method comprising the steps of:

sending a distance measuring control signal from the station equipment to each of the subscriber units;

measuring the transmission line distance based on a distance measuring signal returned from each of the subscriber units; and

judging whether the transmission line distance is larger or smaller than a reference value,

By virtue of this construction, whether the transmission line distance is larger or smaller than a reference value can be judged, the collision or leading data, sent from the subscribers, against each other within the optical transmission line can be prevented, and, thus, it is possible to prevent the subscriber unit under operation from being brought to an inoperative state.

In the method according to the second feature of the invention, preferably,

the station equipment comprises: a transmission line distance monitor/processor unit comprising a distance measuring control signal generator, a distance measuring section, and a distance judgment section: a trailing signal multiplexer; and a leading signal separator, and

a distance measuring control signal generated in the distance measuring control signal generator is multiplied in the trailing signal multiplexer to prepare a trailing signal which is then sent to each of the subscriber units.

According to this construction, the transmission line distance between the station equipment and the subscriber units can be measured, whether the transmission line distance is larger or smaller than a reference value can be judged, the collision of leading data, sent from the subscribers, against each other within the optimal transmission line can be prevented, and, thus, it is possible to prevent the subscriber unit under operation from being brought to an inoperative state.

In this method, preferably, a distance measuring signal is separated from a leading signal, returned from each of the subscriber units, in the leading signal separator to prepare a distance measuring signal that is then input into the distance measuring section which sends a distance signal to the distance judgment section for judging whether the transmission line distance is larger or smaller than a reference value.

According to this construction, the transmission line distance between the station equipment and the subscriber units can be measured, whether the transmission line distance is larger or smaller than a reference value can be judged the collision of leading data, sent from the subscribers, against each other within the optical transmission line can be prevented, and, thus, it is possible to prevent the subscriber unit under operation from being brought to an inoperative state.

In the above methods, preferably, when the transmission line distance is larger than the reference value, an alarm is issued.

According to this construction, when the transmission line distance between the station equipment and a subscriber unit is larger than a reference value, the subscriber unit can be stopped. Therefore, the collision of leading data, sent from the subscribers, against each other within the optical transmission line can be prevented, and, thus, it is possible to prevent the subscriber unit under operation from being brought to an inoperative state.

### BRIEF DESCRIPTION OF THE DRAWINGS

The invention will be explained in more detail in conjunction with the appended drawings, wherein:

FIG. 1 is a block diagram showing the construction of an optical subscriber system according to the invention;

FIG. 2 is a block diagram showing station equipment; and

FIG. 3 is a timing chart of the operation in the transmission line distance monitoring method according to the invention.

### DESCRIPTION OF THE PREFERRED EMBODIMENTS

Preferred embodiments of the optical subscriber system according to the invention will be explained in conjunction with the accompanying drawings.

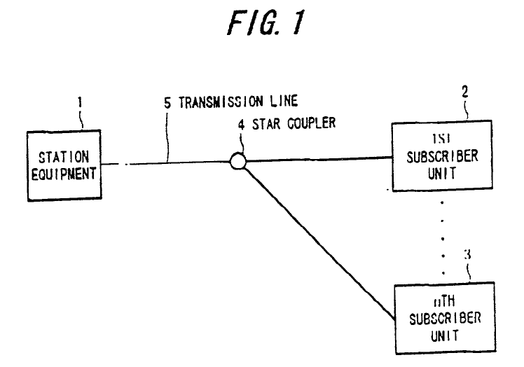

FIG. 1 is a block diagram showing the construction of the optical subscriber system according to the invention.

As shown in FIG. 1, the optical subscriber system according to the invention comprises station equipment 1, n subscriber units (1st subscriber unit 2 to nth subscriber unit 3), a transmission line 5, and a star coupler 4.

The transmission line 5 shown in FIG. 1 transmits trailing signals from the station equipment 1 to the plurality of subscriber units 2, 3 and leading signals from the plurality of subscriber units 2, 3 to the station equipment 1. The star coupler 4 functions to branch trailing signal and, in addition, to combine leading signals.

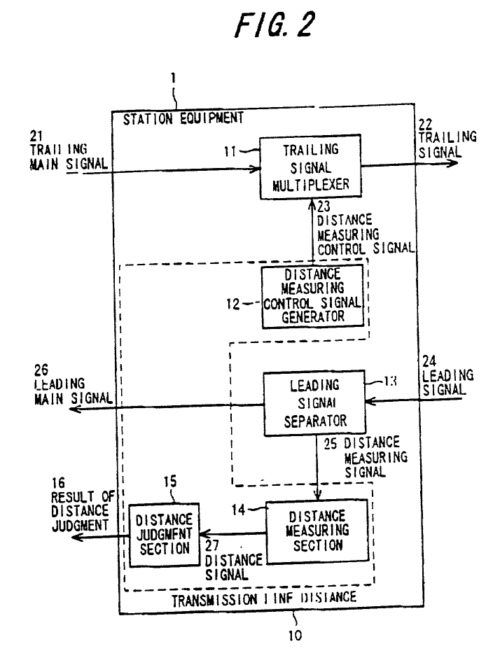

FIG. 2 is a block diagram of the station equipment 1. As shown in FIG. 2, the station equipment 1 comprises: a transmission line distance monitor/processor unit 10 comprising a distance measuring control signal generator 12, a distance measuring section 14, and a distance judgment section 15; a trailing signal multiplexer 11; and a leading signal separator 13.

In the optical subscriber system according to this preferred embodiment, the station equipment 1 comprises the transmission line distance monitor/processor unit 10 which sends a distance measuring control signal 23 to each of the subscriber units, and measure a transmission line distance based on a distance measuring signal 25 returned from each of the subscriber units to judge whether the transmission line distance is larger or smaller than a reference value.

As described above, the transmission line distance monitor/processor unit 10 comprises the distance measuring control signal generator 12, the distance measuring section 14, and the distance judgment section 15.

Further, the station equipment 1 comprises the trailing signal multiplexer 11 and the leading signal separator 13. The distance measuring control signal 23 generated in the distance measuring control signal generator 12 is multiplexed with a trailing main signal 21 in the trailing signal multiplexer 11 and is sent as a trailing signal 22 to each of the subscriber units 2, 3.

A leading signal 24 returned from each subscriber unit is separated in the leading signal separator 13 into a leading main signal 26 and a distance measuring signal 25 which is then input into the distance measuring section 14. In the distance measuring section 14, the transmission line distance between the station equipment 1 and each of the subscriber units 2, 3 is measured, and a distance signal 27 is sent to a distance judgment section 15. The distance judgment section 15 judges, whether the transmission line distance between the station equipment 1 and each of the subscriber units 2, 3 is larger or smaller than a reference value, and outputs the distance judgment result 16. Here the term “reference value” refers to a distance that does not have an adverse effect, on a subscriber unit under operation, such that a transmission line alarm is issued to the subscriber unit under operation and, consequently, the subscriber unit under operation is brought to an inoperative state. The distance as the reference value may be arbitrarily set.

When the result of the judgment in the distance judgment section 15 is that the transmission line distance between the station equipment 1 and each of the subscriber units 2, 3 is larger than the reference value, an alarm is output as the distance judgment result 16.

Next, the transmission line distance monitoring method according to the invention will be explained in conjunction with FIGS. 1 to 3. The transmission line distance monitoring method according to the invention is applied to an optical subscriber system comprising: station equipment 1, a plurality of subscriber units 2, 3; a transmission line 5 which transmits trailing signals from the station equipment 1 to the plurality of subscriber units 2, 3 and leading signals from the plurality of subscriber units 2, 3 to the station equipment 1; and a star coupler 4 which functions to branch trailing signals and to combine leading signals.

In the transmission line distance monitoring method according to the invention, the distance measuring control signal 23 generated in the distance measuring control signal generator 12 is sent to a trailing signal multiplexer 11. The distance measuring control signal 23 sent to the trailing signal multiplexer 11 is multiplexed with the trailing main signal 21 in the trailing signal multiplexer to prepare a trailing signal 22 which is then passed though the transmission line 5 and the star coupler 4 and is sent to each of the subscriber units 2, 3.

Each of the subscriber units 2, 3, which have received the trailing signal 22, multiplexes a distance measuring signal with a leading main signal to prepare a leading signal 24 which is then sent to the star coupler 4. The leading signal 14 is passed through the star coupler 4 and the transmission line 5 and is returned to the station equipment 1. The leading signal 24, which has been returned from each of the subscriber units 2, 3, is input into the leading signal separator 13 in the station equipment 1. In the leading signal separator 13, the leading signal 24 is separated into the distance measuring signal 25 and the leading main signal 26. The distance measuring signal 25 is then input into the distance measuring section 14. In the distance measuring section 14, the transmission line distance between the station equipment and each of the subscriber units 2, 3 is measured, and the distance signal 27 is sent to the distance judgment section 15. The distance judgment section 15 judges, whether the transmission line distance between the station equipment 1 and each of the subscriber units 2, 3 is larger or smaller than the reference value, and outputs the distance judgment result 16. Here the term “reference value” refers to a distance that does not have an adverse effect, on a subscriber unit under operation such that a transmission line alarm is issued to the subscriber unit under operation and, consequently, the subscriber unit under operation is brought to an inoperative state. The distance as the reference value may be arbitrarily set.

When the result of the judgment in the distance judgment section 15 in that the transmission line distance between the station equipment 1 and each of the subscriber units 2, 3 is larger than the reference value, an alarm is output as the distance judgment result 16.

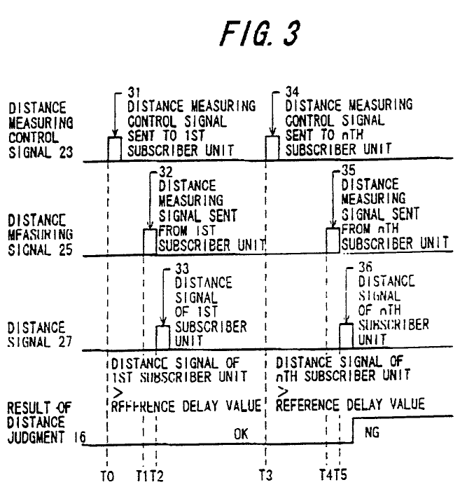

Next, the operation of the transmission line distance monitoring method according to the invention will be explained in conjunction with FIG. 3.

FIG. 3 is a timing chart showing the operation of the transmission line distance monitoring method according to the invention. The station equipment 1 sends at time T0, a distance measuring control signal 311 for a first subscriber unit to the first subscriber unit. The first subscriber unit sends a distance measuring signal 32 to the station equipment 1, and the station equipment 1 receives, at time T1, the distance measuring signal 32 from the first subscriber unit. At time T2, the transmission line distance between the first subscriber unit and the station equipment is computed, and a distance signal 33 for the first subscriber unit is sent to a distance judgment section. In this case, since the transmission line distance, between the first subscriber unit and the station equipment, judged based on the distance signal 33 for the first subscriber unit is smaller than the reference value, any alarm is not issued as the distance judgment result 16.

Next, the monitoring of the transmission line distance between the nth subscriber unit said the station equipment 1 will be explained. In this case, at time T3, the station equipment 1 sends a distance measuring signal 34 to the nth subscriber unit. In response to this, the nth subscriber unit sends a distance measuring signal 35 to the station equipment 1. At time T4, the station equipment 1 receives the distance measuring signal 35 from the nth subscriber unit. At time T5, the transmission line distance between the nth subscriber unit and the station equipment is computed, and a distance signal 36 for the nth subscriber unit is sent to the distance judgment section. In this case, since the transmission line distance, between the nth subscriber unit and the station equipment, judged based on the distance signal 36 sent from the nth subscriber unit is larger than the reference value, an alarm is output as the distance judgment result 16. Upon the issue of the alarm, the start control for the nth subscriber unit is stopped.

As described above, the optical subscriber system according to the invention is provided with a transmission line distance monitor/processor unit which measures the transmission line distance between the station equipment and the subscriber unit and judges whether the transmission line distance is larger or smaller than a reference value. By virtue of this construction, in the optical subscriber system comprising a station equipment, a plurality of subscriber units, a transmission line for transmitting trailing signals from the station equipment to the plurality of subscriber units and transmitting leading signals from the plurality of subscriber units to the station equipment, and a star coupler for branching trailing signals and combining the leading signals, when tho transmission line distance exceeds the reference value, the subscriber unit can be stopped.

Further, in the transmission line distance monitoring method according to the invention, a distance measuring control signal is sent from the station equipment to each subscriber unit, the transmission line distance between the station equipment and each subscriber unit is measured based on a distance measuring signal returned from each subscriber unit, and judgment is made on whether the transmission line distance is larger or smaller than a reference value. By virtue of this construction, according to the transmission line distance monitoring method of the invention, in the Optical subscriber system comprising a station equipment, a plurality of subscriber units, a transmission line for transmitting trailing signals from the station equipment to the plurality of subscriber Units and transmitting leading signals from the plurality of subscriber units to the station equipment, and a star coupler for branching trailing signals and combining the leading signals, when the transmission line distance exceeds the reference value, the subscriber unit can be stopped.

The invention has been described in detail with particular reference to preferred embodiments, but it will be understood that variations and modifications can be effected within the scope of the invention as set forth in the appended claims.

What is claimed is:

1. An optical subscriber system comprising: station equipment: a plurality of subscriber units; a transmission line for transmitting trailing signals from the station equipment to the plurality of subscriber units and transmitting leading signals from the plurality of subscriber units to the station equipment; and a star coupler for branching trailing signals and combing the leading signals,
the station equipment comprising a transmission line distance monitor/processor unit which sends a distance measuring control signal to each of the subscriber units, measures, based on a distance measuring signal returned from each of the subscriber units, the transmission line distance between the station equipment and each of the subscriber units, and judges whether the transmission line distance is larger or smaller than a reference value.

2. The optical subscriber system according to claim 1, wherein the station equipment further comprises a trailing signal multiplexer and a leading signal separator and functions to multiplex the distance measuring equipment signal, generated in the transmission line distance monitor/processor unit, in the trailing signal multiplexer to prepare a trailing signal, which is then sent to each of the subscriber unit, and to separate, from a leading signal returned from each of the subscriber units, a distance measuring signal, in the leading signal separator, which is then sent to the transmission line distance monitor/processor unit.

3. The optical subscriber system according to claim 2, wherein
the transmission line distance monitor/processor unit comprises a distance measuring control signal generator, a distance measuring section, and a distance judgment section, and
the distance measuring control signal generated in the distance measuring control signal generator is multiplexed in the trailing signal multiplexer to prepare a trailing signal, which is then sent to each of the subscriber units, and a distance measuring signal is separated from a leading signal, returned from each of the subscriber units, in the leading signal separator to prepare a distance measuring signal that is then input into the distance measuring section which sends a distance signal to the distance judgment section for judging whether the transmission line distance is larger or smaller than a reference value.

4. The optical subscriber system according to any one of claims 1 to 3, which, when the transmission line distance is larger than the reference value, issues an alarm.

5. A method for monitoring the transmission line distance between station equipment and each of a plurality of subscriber units in an optical subscriber system comprising: station equipment; a plurality of subscriber units; a transmission line for transmitting trailing signal from the station equipment to the plurality of subscriber units and transmitting leading signals from the plurality of subscriber units to the station equipment; and a star coupler for branching trailing signals and combining the leading signals, said method comprising the steps of:
sending a distance measuring control signal from the station equipment to each of the subscriber units;
measuring the transmission line distance based on a distance measuring signal returned from each of the subscriber units; and
judging whether the transmission line distance is larger or smaller than a reference value.

6. The method according to claim 5, wherein
the station equipment comprises: a transmission line distance monitor/processor unit comprising a distance measuring control signal generator, a distance measuring section, and a distance judgment section; a trailing signal multiplexer; and a leading signal separator, and
a distance measuring control signal generated in the distance measuring control signal generator is multiplexed in the trailing signal multiplexer to prepare a trailing signal which is then sent to each of the subscriber units.

7. The method according to claim 6, wherein
a distance measuring signal is separated from a leading signal, returned from each of the subscriber units, in the leading signal separator to prepare a distance measuring signal that is then input into the distance measuring section which sends a distance signal to the distance judgment section for judging whether the transmission line distance is larger or smaller than a reference value.

8. The method according to any one of claims 5 to 7, wherein, when the transmission line distance is larger than the reference value, an alarm is issued.
